(19) United States
(12) Patent Application Publication
(10) Pub. No.: US 2008/0222064 A1
(43) Pub. Date: Sep. 11, 2008

(54) Processes and Systems for Automated Collective Intelligence

(76) Inventor: Daniel J. Larimer, Christiansburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/683,869

(22) Filed: Mar. 8, 2007

(51) Int. Cl. G06F 15/18

(52) U.S. Cl. 706/16

(57) ABSTRACT

The present invention relates to the field of collective intelligence. More specifically, to the collaborative acquisition of knowledge and the relationships among said knowledge and the application of acquired knowledge and relationships to solving problems. The present invention presents an interface to a community of users that will create nodes and relationships in an artificial neural network and then weight each node and relationship through votes from one or more users.

### BACKGROUND OF THE INVENTION

1. Field of the Invention

The present invention relates to the field of collective intelligence. More specifically, to the collaborative acquisition of knowledge and the relationships among said knowledge and the application of acquired knowledge and relationships to solving problems.

2. Description of Related Art

Expert systems, also known as knowledge-based systems, are computer programs that contain some of the subject-specific knowledge of one or more human experts. The most common form of expert systems is a program made up of a set of rules that analyze information (usually supplied by the user of the system) about a specific class of problems.

Expert systems are most valuable to organizations that have a high-level of know-how experience and expertise that cannot be easily transferred to other members. They are designed to carry the intelligence and information found in the intellect of experts and provide this knowledge to other members of the organization for problem-solving purposes.

The problems by expert systems would normally be tackled by a professional in the field. Real experts in the problem domain (which will typically be very narrow, for instance “diagnosing skin in human teenagers”) are asked to provide “rules of thumb” on how they evaluate the problems, either explicitly with the aid of experienced systems developers, or sometimes implicitly, by getting such experts to evaluate test cases and using computer programs to examine the test data and (in a strictly limited manner) derive rules from that. Generally, expert systems are used for problems for which there is no single “correct” solution which can be encoded in a conventional algorithm—one would not write an expert system to find shortest paths through graphs, or sort data, as there are easier ways to do these tasks.

Simple systems use simple true/false logic to evaluate data, but more sophisticated systems are capable of performing at least some evaluation taking into account real-world uncertainties, using such methods as fuzzy logic. Such sophistication is difficult to develop and still highly imperfect.

Some significant shortcomings of most expert systems are the lack of human common sense needed to make some decisions, the creative responses human experts can generate in unusual circumstances, domain experts not always being able to explain their logic and reasoning, the challenges of automating complex processes, the lack of flexibility, inability to adapt to changing environments, and not being able to recognize when no answer is available.

Artificial Neural Nets (ANNs) are another area of artificial intelligence where complex problems are solved by emulating the behavior of neurons in the brain to model learning and encode complex relationships between input data and the expected output of the function to be approximated. A neural network consists of a set of interconnected simple processing elements (neurons) which can exhibit complex global behavior, determined by the connections among the processing elements and element parameters. The original inspiration for the technique was from examination of the central nervous system and the neurons (and their axons, dendrites and synapses), which constitute one of its most significant information processing elements. In a neural network model, simple nodes (called variously “neurons”, “neurodes”, “PEs” (“processing elements”) or “units”) are connected together to form a network of nodes—hence the term “neural network.” While a neural network does not have to be adaptive per se, its practical use comes with algorithms designed to alter the strength (weights) of the connections in the network to produce a desired signal flow.

These networks are also similar to the biological neural networks in the sense that functions are performed collectively and in parallel by the units, rather than there being a clear delineation of subtasks to which various units are assigned. Currently, the term ANN tends to refer mostly to neural network models employed in statistics and artificial intelligence.

In some systems, neural networks, or parts of neural networks (such as artificial neurons) are used as components in larger systems that combine both adaptive and non-adaptive elements. ANNs operate on the principle of non-linear, distributed, parallel and local processing, and adaptation.

The tasks to which artificial neural networks are applied tend to fall within the following broad categories:
1) Function approximation, or regression analysis, including time series prediction and modeling.
2) Classification, including pattern and sequence recognition, novelty detection, and sequential decision-making.
3) Data processing, including filtering, clustering, blind source separation and compression.

Application areas include system identification and control (vehicle control, process control), game-playing and decision making (backgammon, chess, racing), pattern recognition (radar systems, face identification, object recognition and more), sequence recognition (gesture, speech, handwritten text recognition), medical diagnosis, financial applications, data mining (or knowledge discovery in databases, “KDD”), visualization and e-mail spam filtering.

Artificial Neural Networks are generally used to solve problems for which there is no way to easily define a function to map an input to the desired output. As a result, neural networks must learn how to map inputs to output through training in which the network compares its output for a given input with a known or estimated output in order to measure its accuracy and then adjust the weights of the connections among the neurons. Training cases are not always easy to generate.

A good example of the limitation of current expert systems and ANNs are situations where the knowledge base is so large and dynamic that there are no human experts available to teach an expert system or ANN how to answer questions or draw conclusions. One such example is the evaluation of the truth of any statement or opinion.

Other related work can be found in the field of collective intelligence. This field is relatively new, with MIT opening the first-ever academic Center for Collective Intelligence in October 2006. The main area of study at MIT is “How can people and computers be connected so that—collectively—they act more intelligently than any individuals, groups, or computers have ever done before.” Some current implementations of collective intelligence include websites such as Slashdot, Digg, and Wikipedia. One of MIT's projects is a collectively written book “We are smarter than me.” Most of these approaches use a combination of shared editing (Wikipedia), voting (Digg), and communication (e-mail, forums, etc) to generate an intelligent output. Usually this output is the aggregation and compilation of information provided by a community of users. Shared editing is limited to the expression of ideas that can be understood by one or more individuals. Voting is limited by an individual's ability to access all facts required to make an intelligent vote, and in most applications communication among individuals is slow, time consuming, and error prone. None of these techniques have successfully reached a “logical” conclusion based upon more information than one individual person can understand because all conclusions ultimately come down to a decision made by an individual. Voting does not work if the majority of the voters are incapable of understanding all facts and relationships relevant to the topic they are voting on. Additionally, the collaborative compilation of information from multiple sources does not provide any automated reasoning to estimate the truthfulness, accuracy, or relevance of said compilation. In effect, the vast majority of current approaches to collective intelligence do little more than facilitate inter-personal collaboration and/or provide error checking through redundancy. Voting systems usually tend toward average intelligence instead of maximum intelligence.

One of the ways that collective intelligence has been applied successfully is through collaborative estimation of a measurable value. For example, if a room of 100 people were asked to estimate the number of coins in a jar, then the average of all estimates will be better than 95% of all individual estimates. Further, if you repeated the experiment multiple times, no individual could consistently beat the average estimate. Unfortunately this approach is fundamentally limited by being unable to explain the reasons behind the estimates.

Other areas of research in collective intelligence include a concept called the semantic web. This research focuses upon using structured organization of information, such as XML, to enable computers to understand the meaning of content on a web page. This approach depends upon standard representations of data and significant effort on the part of publishers to make their information available in a form that can be understood by a computer. The semantic web is still in need of a general-purpose representation of data and a means to represent abstract meaning of information. Ultimately, the semantic web only serves to enhance the automatic aggregation of data and does little to provide general-purpose collective reasoning.

Other forms of collective intelligence include the concept of folksonomy. A folksonomy is an Internet-based information retrieval methodology consisting of collaboratively generated, open-ended labels that categorize content such as Web pages, online photographs, and Web links. A folksonomy is useful for identifying related information; however, it cannot reason about the meaning of a relationship.

### SUMMARY OF THE INVENTION

The present invention relates to the field of collective intelligence, specifically to the collaborative building of artificial neural nets. The present invention further relates to the representation of knowledge items, relationships among items, and the acquisition of said knowledge items and relationships from a community of users (e.g. at least one user or a plurality of users). One useful output of the present invention is a confidence measure in the truth or falsehood of each knowledge item where truth is measured by the relative strength of related supporting and contradicting knowledge items. According to the invention, systems and methods are provided comprising an artificial neural network comprising a first node and at least one second node. Each of said nodes is associated with at least one media. Each of said nodes is created by a user. Further, relationship(s) between said nodes are created by user(s). The relationship(s) comprise numerically weighted connections between an output of one node and an input to another node, where the weight is specified by one or more users. Output from said first node is calculated as a function of the output of said second node and said weight provided by a user. Output optionally serves as input to said second node. Further, methods for generating output from an artificial neural network are also provided comprising creating at least one node in an artificial neural network by user interfacing, wherein each of said nodes is associated with at least one media. The nodes are linked (related or connected) with at least one other node by user interfacing. The methods further comprise voting, by user interfacing, on a numerical weight of said linking. With at least one algorithm, a calculation is performed to generate a numerical output for each of said nodes based upon said numerical weight of said linking. The calculation can optionally be further based upon input from at least one other node.

Using a Collaborative Artificial Neural Network (CANN) the present invention draws conclusions that incorporate more information than any individual person could consider. Instead of training the artificial neural network with thousands of test cases, the CANN automatically grows and learns as a community of users create new nodes, connect (link or relate) them together, and vote on the weight of the connections. The CANN can be constructed in such a way so that the system is dynamic in one or several respects. For example, the CANN system can be dynamic in the total number of nodes and/or in the total number of relationships between the nodes. In preferred embodiments, the CANN system comprises a dynamic number of relationships, where more than one relationship exists between certain nodes. Research shows that when a group of individuals make an independent estimate of a measurable value (coins in ajar, relationship of two pieces of information), that their average measurement is consistently more accurate than any individual's over many test cases.

The human brain typically only considers a limited number of factors in making decisions; therefore, it must abstract complex problems (simplify, generalize, or eliminate data) in order to reason and draw conclusions. Comparatively, the present invention is potentially capable of generating better conclusions because it does not need to simplify and generalize data, but can consider all data and relationships in making an evaluation.

The present invention also overcomes the shortcomings of current expert systems and ANNs by factoring human common sense and creative human responses into a generic algorithm that is easy to automate. It may easily adapt to changing environments because of the human interaction with the system. The present invention is capable of reasoning on the entirety of knowledge known to mankind that can be expressed in writing, video, audio, pictures, or other media and organized and related logically by humans. It is capable of reasoning on this knowledge based upon the contributions of many users. The net effect of the present invention is a collective intelligence that is potentially far greater than any individual contributor.

A community using a CANN may come to better conclusions than the same community without the help of a CANN. One example of where this may happen is when individual users are voting for a presidential candidate. These voters base their decisions on a small subset of potentially inaccurate information and they have limited means to evaluate all of the necessary information; therefore, the outcome of an election is often based more on emotion, popularity, and gut feeling than logic, reason, and values. With the CANN an entire society could debate the issues and come to a conclusion that represents the collective intelligence instead of (at best) average intelligence.

### BRIEF DESCRIPTION OF THE DRAWINGS

Elements of the figures are generally numbered such that the first digit corresponds to the figure number and the second two digits correspond to the portion of the figure.

FIG. 1 represents an example problem consisting of five points (nodes) and 16 relationships among the points. Boxes represent the points, and the lines between the boxes represent the relationships. A relationship consists of two parts, a conditional (circle) and a weight (arrow). The relationship connects or links two points.

The point at the end of the line with an arrow is either supported or contradicted by the point at the end of the line with a circle. A filled arrow represents support, an empty arrow represents a contradiction, and no arrow represents no relationship between the two points (i.e., that the point at the end of the line with the circle neither supports or contradicts the point at the end of the line with the arrow. The size of the arrow corresponds to the magnitude of the support or contradiction weight. A filled circle represents the condition that the point has more supporting evidence than contradicting evidence. An empty circle represents the condition that the point has more contradicting evidence than supporting evidence.

FIGS. 2a and 2b represent the general flow of logic and the location of various algorithms within the CANN. Both of FIGS. 2a and 2b show where user input is applied within the CANN. Further, FIGS. 2a and 2b show the flow of logic, inputs and outputs to the mathematical functions. FIG. 2b represents an alternative means to specify the weights applied to the inputs from a node. Specifically, the output of a first node can serve as the weight applied to the output of a second node that is then used as an input to a third node.

FIG. 2c represents a traditional artificial neural network and is provided for comparison with FIGS. 2a and 2b. This comparison will serve to highlight some of the differentiating features shown in FIGS. 2a and 2b such as: the associated media and input from users.

FIG. 3 shows an example web-based interface for adding a new text media node to the CANN.

FIG. 4 shows an example web-based interface for voting on the weight of the relationship between two points.

### DETAILED DESCRIPTION OF VARIOUS EMBODIMENTS OF THE INVENTION

Reference will now be made in detail to various exemplary embodiments of the invention. It is to be understood that the following detailed descriptions are presented for the purpose of describing certain embodiments and examples in detail. Thus, the following detailed description is not to be considered as limiting the invention to the embodiments described. Rather, the true scope of the invention is defined by the claims.

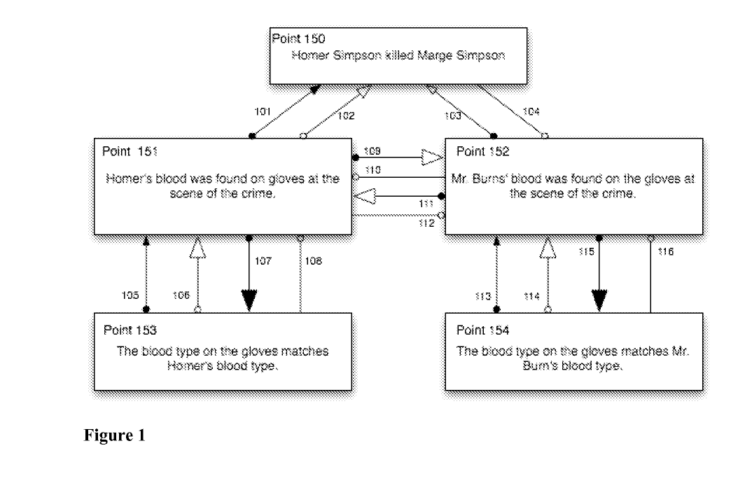

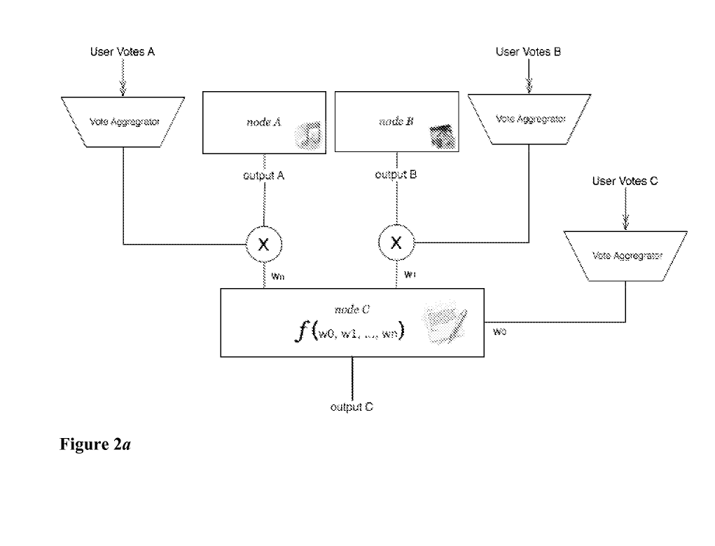

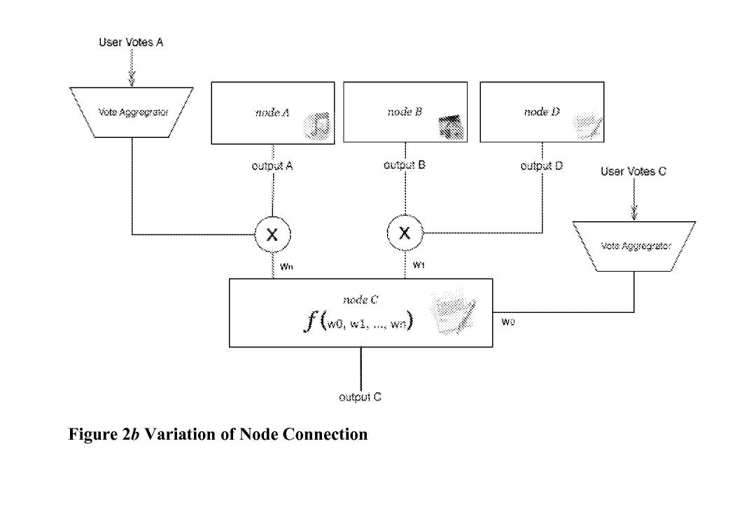

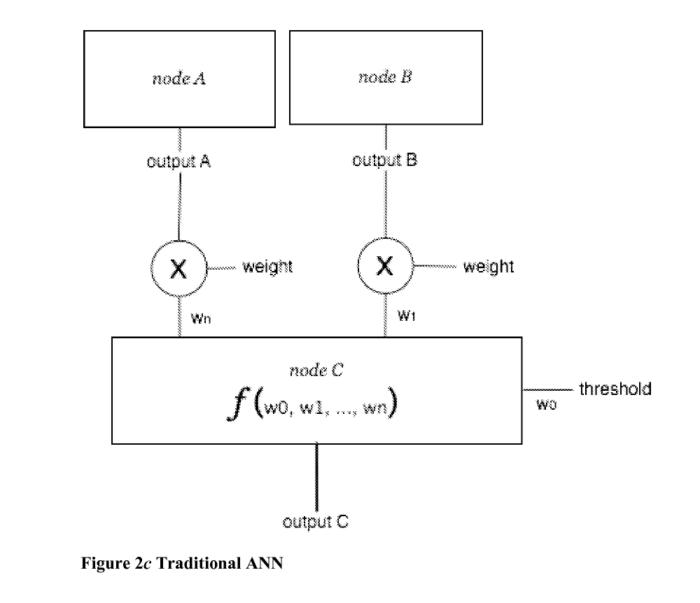

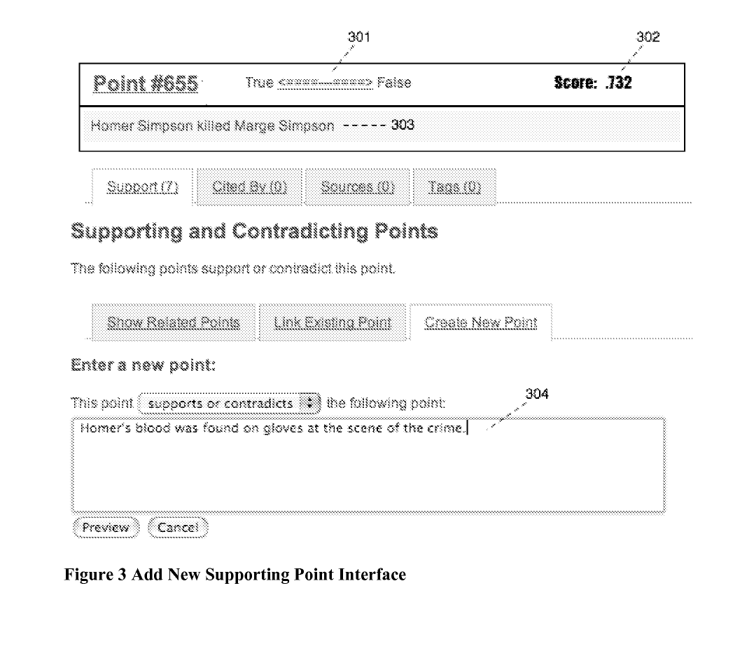

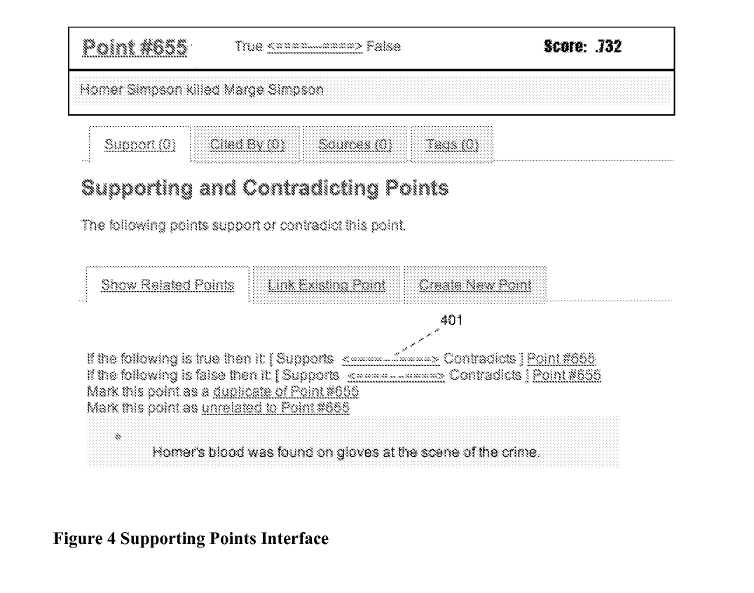

FIG. 1 provides an example of potential data stored in one potential data structure used by the present invention. In this example, the system is attempting to determine whether or not Homer Simpson killed Marge Simpson.

Point 150 is provided by a user or by the system. Other users in the community have provided two assertions, 151 and 152, that they believe either support or contradict the assertion that Homer killed Marge. They have created 8 relationships, 101, 102, 103, 104, 109, 110, 111, and 112 among points 150, 151, and 152.

Point 151 asserts that Homer's blood was found on gloves at the scene of the crime, and point 152 asserts that Mr. Burns' blood was found on the gloves.

Relationship 101 reads as, “if point 151 is supported, meaning Homer's blood was found on the gloves, then point 151 supports point 150 that Homer killed Marge.” Thus, relationship 101 is represented by a line having a filled circle at point 151 and a relatively small filled arrow at point 150.

Relationship 102 reads as, “if point 151 is not supported, then point 151 contradicts the assertion 150 that Homer killed Marge.” Relationship 102 is, thus, represented by a line having an empty circle at point 151 and a relatively small empty arrow at point 150.

Relationship 103 captures the fact that if Mr. Burns' blood was found on the gloves, then it is a contradiction to point 150. Thus, relationship 103 is represented by a line having a filled circle at point 152 and a relatively small empty arrow at point 150.

Relationship 104 captures the fact that if the blood was not Mr. Burns' blood, then point 152 neither supports nor contradicts point 150 (which is shown by relationship 104 having an empty circle and no arrow).

Relationship 109 says that if point 151 is proven (i.e., that it was Homer's blood), then it strongly contradicts point 152 (that it was Mr. Burns' blood). Likewise, relationship 111 says that if it is proven that it was Mr. Burns' blood, then it strongly contradicts that it was Homer's blood. Accordingly, relationships 109 and 111 are represented by a line having a filled circle and a relatively large empty arrow.

Relationships 110 and 112 show no relationship between points 151 and 152. This is indicated with lines having an empty circle and no arrow. If Mr. Burns' blood was not found on the gloves, this fact has no bearing on whether Homer's blood was found, and vice versa.

At this point the community realizes that they require more evidence to determine whether or not point 151 or point 152 is true. Users then contribute assertions 153 and 154 to the system. These assertions attempt to match the blood on the gloves to an individual via blood type.

In this situation, relationship 105 says that if the blood type matches Homer's, that it adds some, but not a lot of, support to assertion 151 that it was Homer's blood. Thus, relationship 105 shows a line having a filled circle and a relatively small filled arrow to show a lightly weighted supporting relationship between points 153 and 151.

Relationship 106 says that if the blood types do not match then it strongly contradicts that it was Homer's blood. Accordingly, relationship 106 shows a heavily weighted contradiction shown by an empty circle and a relatively large empty arrow.

Relationship 107 says that if it is proven that it was Homer's blood, then it strongly supports that the blood types match, which is shown by a filled circle and a relatively large filled arrow.

To the contrary, relationship 108 says that if it is proven that it was not Homer's blood, then it says nothing about whether or not Homer's blood type matches. Relationship 108 is, thus, represented by an empty circle and no arrow.

Relationships 113-116 follow the same pattern as relationships 105-108.

There are multiple mathematical techniques that can be used to evaluate the data structure represented by FIG. 1 to determine which points are well supported and which ones are not. One such mathematical calculation is presented below as an example.

Let each point have a score between −1 and 1 such that −1 represents 100% contradicting evidence and 1 represents 100% supporting evidence. It follows that 0 would represent 50% supporting and 50% contradicting evidence.

Let scores greater than 0 evaluate to supported and less than 0 evaluate to contradicted. Let each arrowhead represent a value between −1 and 1 such that the magnitude of the value (weight) corresponds to the size of the arrowhead. Let negative values represent an empty arrowhead while positive values represent a filled arrowhead. The contribution of a relationship between two points can be calculated by multiplying the score of the point (whether supporting or contradicting) by the magnitude of the value (weight) of the relationship. The sign of the contribution (controlled by the positive or negative value of the score) determines whether, respectively, one point supports or contradicts another.

The contribution of a relationship must be recalculated each time the score of the supporting or contradicting point changes, and the score of the supporting or contradicting point must be updated every time the contribution of a relationship changes. These calculations can be done in an iterative manner. Typically, circular relationships will bounce back and forth for a few iterations until the values stabilize, as the mathematics presented above will result in dampening effect because all values are between −1 and 1.

While one individual could easily evaluate the facts of this case and draw a logical conclusion, it is not difficult to imagine situations where no one individual knows all of the evidence and where the most appropriate conclusion is not clear even when all of the evidence has been provided. Examples of these kinds of problems include evaluating every statement made by a politician or determining whether or not to withdraw troops from an occupied country.

While the data structure and calculations described above are capable of evaluating generic problems, a practical solution to populate the data structure in a meaningful and accurate manner would prove beneficial. Current expert systems depend upon highly structured logical expressions to draw conclusions using languages such as Prolog. The precise logic used is traditionally provided by a small group of experts making large expert systems with dynamic data and logic requirements difficult to build and maintain. The knowledge and skill required to enter data and logic in this manner is too great for a community of users to effectively collaborate. Traditional artificial neural networks would require an impractical and likely impossible amount of training to generate the appropriate weights on the network edges.

The data structures used by the present invention enable human users to express knowledge and arguments in natural language, audio, video, or pictures because a community of users will judge the meaning of arguments and relationships and not a computer. The present invention assumes that the majority of people are capable of providing a reasonable and logical rating for a relationship between two media. No one individual is required to understand more than one relationship at a time and a relationship may require input from many users in order to achieve a strong confidence level, which will contribute to the magnitude of the weight.

The present invention may use many different interfaces to gather input from a community of users. The preferred interface would be a website where users may view an assertion (point, node) and all of the related assertions (points, nodes). The interface would allow a user to vote on the degree to which one assertion supports or contradicts another assertion. This interface could be similar to many modern threaded discussion forums. Users may reply to one assertion with a new assertion or link two existing assertions together using HTML forms or other input techniques. Other potential implementations could include client/server or peer-to-peer applications running on an individual user's computer or through a web browser. Particular user interfacing that can be incorporated into the collaborative artificial neural networks and methods and systems comprising them according to the invention can include any means known for user interfacing, such as for example by way of web page, Desktop Graphical User Interface, and/or by mobile device, or any combination thereof.

FIGS. 3 and 4 demonstrate one exemplary web-interface to the CANN. In FIG. 3 the user is shown a text media 303 for a node in the CANN. The current output 302 of this node is displayed along with an interface 301 to vote on the truth or falsehood of text media 303. The user is provided with an interface 304 to create a new node to be linked as an input to the node representing text media 303. FIG. 4 shows how the linked node created with interface 304 could appear. Interface 401 could enable a user to vote on the relative weight (support or contradiction) applied to the output of a related media's node.

The knowledge data structure may be easily implemented using a relational database. A simple database could contain two database tables, one for assertions, and one for relationships. The assertion table would contain a unique assertion identifier, the user-entered media, and a current output. The relationship table could contain two assertion identifiers, a relationship weight if the supporting point is supported, and a relationship weight if the supporting point is contradicted.

There are many potential variations to the present invention including, the dynamic weighting of user input from different users according to their historic accuracy, adding additional objects and relationships to the data structure, including source citations, and the relationship between sources and assertions. The data structure may also be adapted to support relating assertions, points, or arguments to individual people or organizations. Additional types of relationships and properties may be defined such as relevance, fact/opinion, importance, accuracy, or other property and one or more individuals may vote on a score for these properties.

Not all nodes would have to perform the same calculations. Potential node functions include: Sigmoid, Gaussian, Sine, AND, OR, XOR, NOT, etc. For example, some nodes could perform an ‘AND’ operation on two related nodes and only generate strong positive output if both input nodes are strongly supported. If only one input is strongly supported and the other is strongly contradicted then it would generate a strong negative output. It could generate a neutral output if either input is neutral and no input is strongly negative. Additionally, output from one node is not required to serve as input to another node. For example, the numerical output generated by a node is immediately usable by a human to evaluate a quality of the associated media. Optionally, output from a node can serve as an input to another node. Other types of nodes could include a node that generates a strong positive signal if a related node is neutral and a strong negative output if the input is either strongly positive or negative. Nodes of the networks, systems, and methods of the invention can be associated with at least one media. Media can be any source capable of providing data or information, including text, audio, video, HTML, pictures, numbers, logic, programs, or raw data to name a few, for example.

Other types of nodes could include nodes associated with media that is dynamic in nature. For example, dynamic media associated with such nodes could include comparisons to outside data such as stock prices, sensor inputs, current weather, inflation rate, exchange rates, etc. Indeed, any data feed from an outside source can be included. Data sources may also include any sensor, instrument, or output of an external program, where the data output is typically, but not necessarily, dynamic. Users of the CANN could create nodes of different types as needed and connect them together as they see fit. The weight of all relationships would be determined using a vote from one or more users. In addition to defining a relationship through direct human input, the weight of a relationship may also be specified with the output of another node.

In addition to storing the current output state, each node may also store a complete history of its output value at any point in time. Other nodes could then be created that use the historical value of an output of another node as an input. This is useful to enable the CANN to reason on its historical reasoning in the same way that an individual person can reason on their previous conclusions about a topic that have since changed.

The implementation of the CANN is straightforward and easily accomplished by those skilled in the field of artificial neural networks. Those skilled in the art are generally familiar with artificial neural networks and the specific mathematical functions that may be used to calculate an output for a node. Further, those skilled in the art are likewise familiar with the nuances in implementing a neural network using a variety of programming languages. For example, an average web developer could easily build a database and interface for storing and manipulating the CANN using the descriptions and diagrams presented.

There have been many implementations of databases that link different types of media together, apply weights to said links, and provide an interface to enable a community of users to collectively organize and link said information. At a very basic level this describes the World Wide Web. What makes the present invention novel is the organization and weighting of information and relationships according to a logic within an ANN. Existing systems can identify related or relevant material, but they cannot reason on the material itself, only on its connectedness to other materials or other circumstantial measures, such as how frequently the material is visited.

Very generally, some of the differences between ANN and CANN include:
1) ANN has fixed number of inputs and outputs vs. CANN has unlimited inputs and every node is an output.
2) ANN is trained by learning algorithms vs. CANN is trained by one or more users.
3) Internal ANN nodes have no “defined” meaning vs. CANN every node has a meaning “defined” by the associated media.

Additionally, some of the differences between collaborative filtering and CANN include that collaborative filtering assigns numeric values to items to enable a computer to sort them and that the only logic a computer understands is a comparison among values assigned to each item. The CANN, however, is capable of determining the values of items based upon the relationships to other items. Such values generated by CANN may then be used for sorting.

One advantage of the present invention is that it is capable of enabling a computer system to reason logically on complex problems with the input from a large community of users to generate an adaptive artificial neural network capable of drawing rational conclusions about qualities of many different medias.

There are many potential applications of the present invention to specific fields such as the medical industry or patent evaluation. The patent office is currently exploring methods to enable the public to peer review patents in an attempt to process the growing volume of applications. All of the current approaches generate a large body of reviews that the patent office must then process in order to make a decision. Further, due to the complexity of patent evaluation most individuals are not qualified to participate. Participation is sometimes limited when key individuals withhold their input because they do not wish to make a public statement (for various political reasons). The present invention could enable a means for the public to debate a patent and its details and allow the community to come to a conclusion as to whether or not an invention is unique. Such conclusions possible with the present invention can exceed the abilities of existing systems because the collaborative aspects of the present invention, unlike existing systems, allow for human common sense and creative human responses to be factored into the conclusion process. Further, the conclusions possible in this context, as with any information-gathering or debate-based situation, are superior to existing systems at least in part because the present invention is capable of reasoning on the entirety of knowledge known to mankind that can be expressed in writing, video, audio, pictures, or other media and organized and related logically by humans.

The medical industry produces many new ideas and theories that must be peer reviewed; however, professionals are often afraid to risk their reputation by reviewing controversial topics such as abortion, acupuncture, etc. The present invention could enable medical professionals to debate the merits of a new idea based upon the logical organization of facts without risking their reputation. For example, the processes, systems, and networks of the present invention could be configured so that users could participate in such debates while remaining anonymous or semi-anonymous. The resulting body of knowledge could bring more information forward and lead to new discoveries as professionals who are not collaborating today are provided an avenue to collaborate.

Yet another potential application of the present invention is to enable a community of users to automatically make decisions and take actions. In this application the outputs of one or more nodes may cause a direct action such as: purchasing stock, electing an official, giving an individual a bonus, sending an e-mail or other communication, etc. These direct actions can occur automatically without the need for an individual to interpret the output and make a decision.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only.

1. An artificial neural network comprising:
a first node and at least one second node, wherein
each of said nodes is associated with at least one media;
each of said nodes is created by a user;
at least one relationship between said nodes is created by a user; and
output from said first node is calculated from a numerical weight of said relationship and is optionally an input to said second node.

2. The artificial neural network according to claim 1, wherein said at least one media is chosen from text, audio, video, HTML, pictures, numbers, logic, programs, or raw data.

3. The artificial neural network according to claim 1, wherein said at least one media comprises dynamic content.

4. The artificial neural network according to claim 3, wherein said dynamic content is associated with output from an external source.

5. The artificial neural network according to claim 4, wherein said output is a data feed or is data from a sensor or instrument.

6. The artificial neural network according to claim 1, wherein said output corresponds to a quality of said media.

7. The artificial neural network according to claim 1, wherein a total number of said nodes is dynamic.

8. The artificial neural network according to claim 1, wherein a total number of said relationships is dynamic.

9. The artificial neural network according to claim 1, wherein said weight is user specified.

10. A method for generating output from an artificial neural network comprising:
creating at least one node in an artificial neural network by user interfacing, wherein each of said nodes is associated with at least one media;
linking said node with at least one other node by user interfacing;
voting, by user interfacing, on a numerical weight of said linking; and
calculating, with at least one algorithm, a numerical output for each of said nodes based upon said numerical weight of said linking and optionally based upon input from at least one other node.

11. The method according to claim 10, wherein said user interfacing is performed by a plurality of users.

12. The method according to claim 10, wherein said user interfacing is performed by way of at least one web page.

13. The method according to claim 10, wherein said user interfacing is performed by way of at least one Desktop Graphical User Interface.

14. The method according to claim 10, wherein said user interfacing is performed by way of at least one mobile device.

15. The method according to claim 10, wherein said at least one media is chosen from text, audio, video, HTML, pictures, numbers, logic, programs, or raw data.

16. The method according to claim 10, wherein said at least one media comprises dynamic content.

17. The method according to claim 16, wherein said dynamic content is associated with output from an external source.

18. The artificial neural network according to claim 17, wherein said output is a data feed or is data from a sensor or instrument.

19. The method according to claim 10, wherein said voting is weighted by a comparison of historic user votes with the historic weighted average of all votes.

20. The method according to claim 10, wherein said calculating is solely based upon said voting when there is no input from at least one other node.

21. The method according to claim 10, wherein a history of said output for each of said nodes is maintained and referenced as input to other nodes.

22. The method according to claim 10, wherein said at least one media is an algorithm description corresponding to logical operations for calculating based upon input from at least one other node.

23. The method according to claim 10, wherein the weight of said input to at least one other node is determined by an output of another node.

24. The method according to claim 10, wherein said output may be used to cause a direct action.
